(19) United States
(12) Patent Application Publication
(10) Pub. No.: US 2012/0151708 A1
(43) Pub. Date: Jun. 21, 2012

(54) AIR DRIVEN HARD SURFACE CLEANING TOOL

(75) Inventors: Jeffrey W. Carter, Provo, UT (US); Kelly H. McCloy, Murray, UT (US); Paul D. Kappos, North Salt Lake City, UT (US)

(73) Assignee: Pearl Enterprises, LLC, North Salt Lake City, UT (US)

(21) Appl. No.: 13/239,142

(22) Filed: Sep. 21, 2011

Related U.S. Application Data
(63) Continuation of application No. 11/518,373, filed on Sep. 7, 2006, now abandoned.
(60) Provisional application No. 60/715,029, filed on Sep. 7, 2005.
(60) Provisional application No. 60/832,172, filed on Jul. 19, 2006.

(51) Int. Cl. A47L 5/14

(52) U.S. Cl. 15/345

(57) ABSTRACT

An apparatus for cleaning solid surfaces includes a housing configured to substantially encapsulate a surface being cleaned, a vacuum port traversing the housing, a high speed rotating coupler assembly rotatably coupled to the housing, a plurality of impeller blades coupled to the high speed rotating coupler, at least one fluid jet coupled to the impeller blades, and at least one air pathway configured to pass input air past the impeller blades to rotatably drive the impeller blades.

### RELATED APPLICATIONS

The present application claims the benefit under 35 U.S.C. §119(e) of Provisional Application Ser. No. 60/715,029, filed Sep. 7, 2005 and Provisional Application Ser. No. 60/832,172, filed Jul. 19, 2006, both of which are titled Air Induction Improvement to Existing Hard Surface Cleaning Tools, which applications are incorporated herein by reference in their entireties.

### BACKGROUND

Surface cleaning apparatuses vary in both shape and design. However, almost all traditional solid surface cleaning apparatuses include a water source that provides water and/or cleaning agents to a number of high pressure jets. The high pressure jets impart a force on the surface to be cleaned, thereby removing unwanted debris and material.

Many solid surface cleaning apparatuses include a rotating jet system. According to these traditional systems, one or more jets are positioned at the end of an arm. The arm is then coupled to a high speed rotating coupler. According to this traditional system, the high pressure jets at the end of the arm are placed at a relatively extreme angle relative to the surface being cleaned, so that they may impart a horizontal force component on the arm, thereby inducing rotation of the arm about the high speed rotating coupler. However, these traditional solid surface cleaning apparatuses are often plagued by less than satisfactory cleaning swaths or an inability to clean recessed areas on solid surfaces. Often, the inability to clean recessed areas on solid surfaces is attributed to the high angle needed on a rotating cleaning head to produce head rotation.

### SUMMARY

According to one exemplary embodiment, an apparatus for cleaning solid surfaces includes a housing configured to substantially encapsulate a surface being cleaned, a vacuum port traversing the housing, a high speed rotating coupler assembly rotatably coupled to the housing, a plurality of impeller blades coupled to the high speed rotating coupler, at least one fluid jet coupled to the impeller blades, and at least one air pathway configured to pass input air past the impeller blades to rotatably drive the impeller blades.

According to one exemplary embodiment, the at least one air pathway includes a plurality of air inlet ports formed in the housing adjacent to the plurality of impeller blades, wherein the impeller blades are configured to rotate the high speed rotating coupler by air induced from the plurality of air inlet ports.

According to one alternative embodiment, the at least one air pathway includes a water/air pickup path leading to a system vacuum hose. According to one exemplary embodiment, the use of air to drive the rotation of the high speed rotating coupler assembly of a solid surface cleaning tool imparts a rotating force on the jet assembly, allowing for a more perpendicular spray jet angle and improved surface cleaning at lower speeds.

### BRIEF DESCRIPTION OF THE DRAWINGS

The accompanying drawings illustrate various embodiments of the present system and method and are a part of the specification. The illustrated embodiments are merely examples of the present system and method and do not limit the scope thereof.

FIG. 1 illustrates a partial cross-sectional view of the present solid surface cleaning head, including an air-flow path, according to one exemplary embodiment.

FIG. 2 illustrates a full cross sectional view of the present solid surface cleaning head including the multiple air induction ports, according to one exemplary embodiment.

FIG. 3 illustrates a bottom view of the present solid surface cleaning head, according to one exemplary embodiment.

FIG. 4 illustrates a jet angle cleaning recessed surface imperfections, according to one exemplary embodiment.

FIG. 5 illustrate a cross-sectional side view of a solid surface cleaning head configured to drive a turbine with both intake air and dirty water, according to one exemplary embodiment.

Throughout the drawings, identical reference numbers designate similar, but not necessarily identical, elements.

### DETAILED DESCRIPTION

An exemplary system and method for forming an air driven solid surface cleaning apparatus are disclosed herein. Specifically, the exemplary solid surface cleaning apparatus includes an air pathway, such as one or more air inlet ports in its housing or a water/air take up pathway, and a number of impeller blades coupled to the high speed rotating coupler assembly to impart a rotating force on the jet assembly, allowing for a more perpendicular spray jet angle and improved surface cleaning at lower speeds. Embodiments and examples of the present exemplary systems and methods will be described in detail below.

Unless otherwise indicated, all numbers expressing quantities, measurements, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present disclosure.

In the following description, for purposes of explanation, numerous specific details are set forth in order to provide a thorough understanding of the present system and method. It will be apparent, however, to one skilled in the art, that the present method may be practiced without these specific details. Reference in the specification to “one embodiment” or “an embodiment” means that a particular feature, structure, or characteristic described in connection with the embodiment is included in at least one embodiment. The appearance of the phrase “in one embodiment” in various places in the specification are not necessarily all referring to the same embodiment.

### Exemplary System

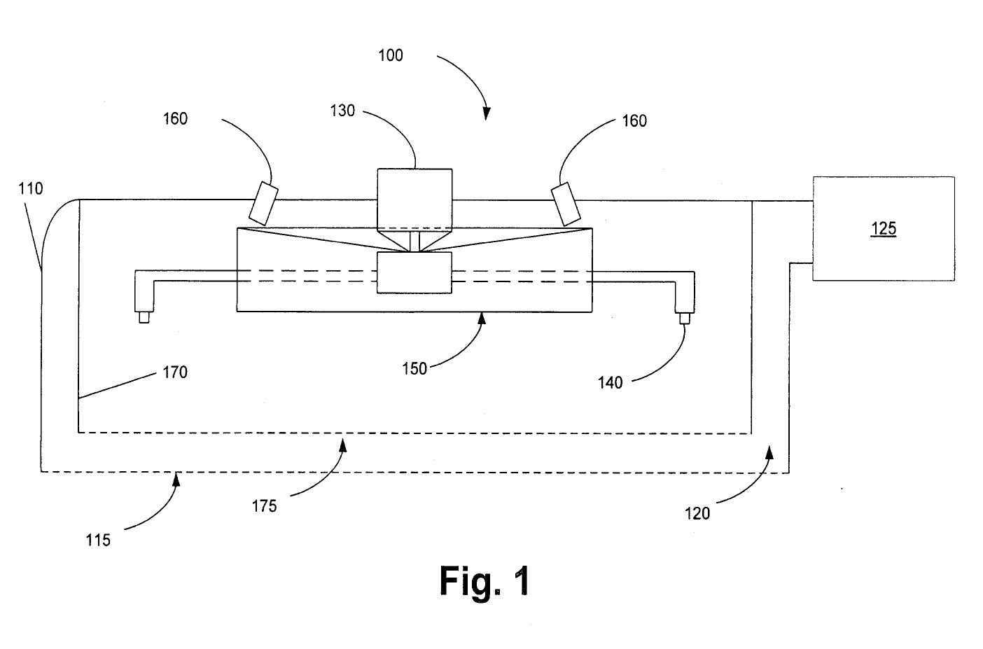

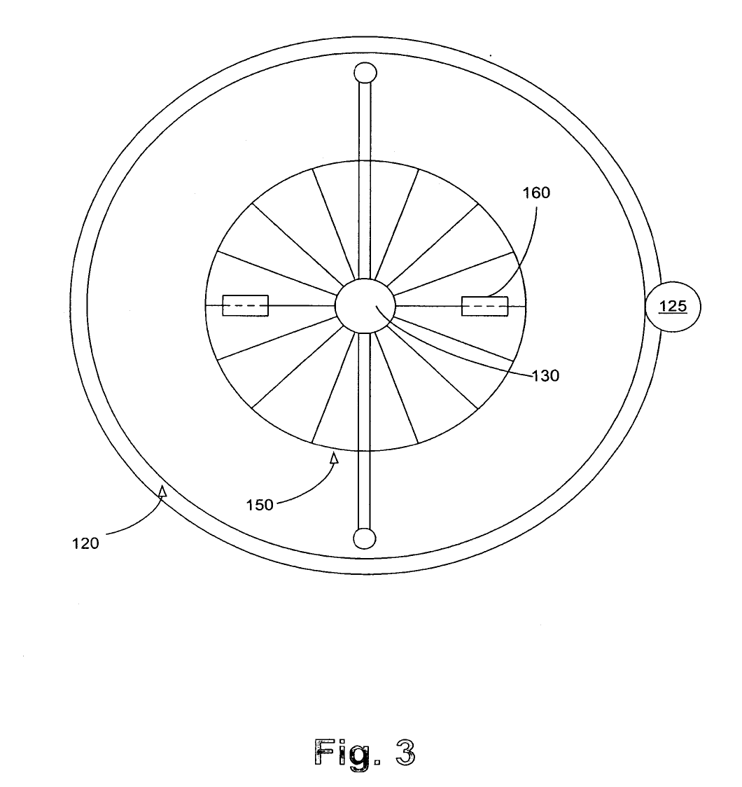

FIGS. 1 and 3 illustrate an air driven surface cleaning apparatus, according to one exemplary embodiment. As illustrated in FIGS. 1 and 3, the air driven surface cleaning apparatus (100) includes a number of components including, but in no way limited to, an outer housing (110) and a raised inner housing (170) defining a cleaning space. As shown, the space located between the outer housing (110) and the raised inner housing (170) form a vacuum port (120) that leads to a vacuum source (125). Additionally, as illustrated in FIG. 1, a plurality of water jets (140) are rotatably coupled to a high speed rotating coupler (130). According to one exemplary embodiment, a pressurized water source (not shown) provides pressurized water and/or cleaning solvents and materials to the water jets (140), causing the water jets to impart a high pressure cleaning stream onto a desired surface located below the defined cleaning space.

As mentioned, traditional hard surface cleaning apparatuses included many of the above-mentioned components. However, in contrast to traditional cleaning systems, the present exemplary surface cleaning apparatus (100) also includes a fan blade or impeller (150) coupled to the high speed rotating coupler (130). According to the exemplary embodiment illustrated in FIG. 1, the fan blade or impeller (150) is coupled to the high speed rotating coupler assembly (130) such that the blades of the impeller are disposed near the top of the inside of the cleaning space. According to one exemplary embodiment, the fan blade or impeller (150) is coupled to the high speed rotating coupler assembly (130) by any number of coupling methods including, but in no way limited to, an adhesive, welding, and/or any number of mechanical fasteners, and the like.

In addition to the high speed rotating coupler (130), one or more air inlet ports (160) were added just above the impeller blades (150) through the outer housing (110) of the exemplary surface cleaning apparatus (100). Moreover, according to one exemplary embodiment, the existing vacuum relief port found on traditional surface cleaning apparatuses (not shown) is removed or otherwise blocked. According to one exemplary embodiment described in further detail below, the inclusion and placement of the air induction ports (160) on the outer surface (110) of the present exemplary cleaning apparatus (100) adjacent to the fan blades or impellers (150) provides for driving rotation of the water jets (140) about the high speed rotating coupler (130).

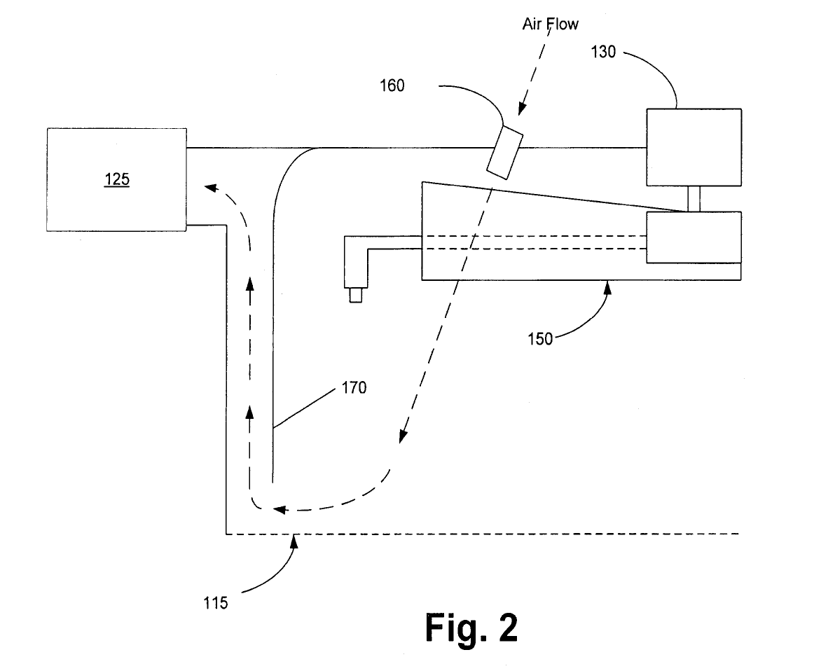

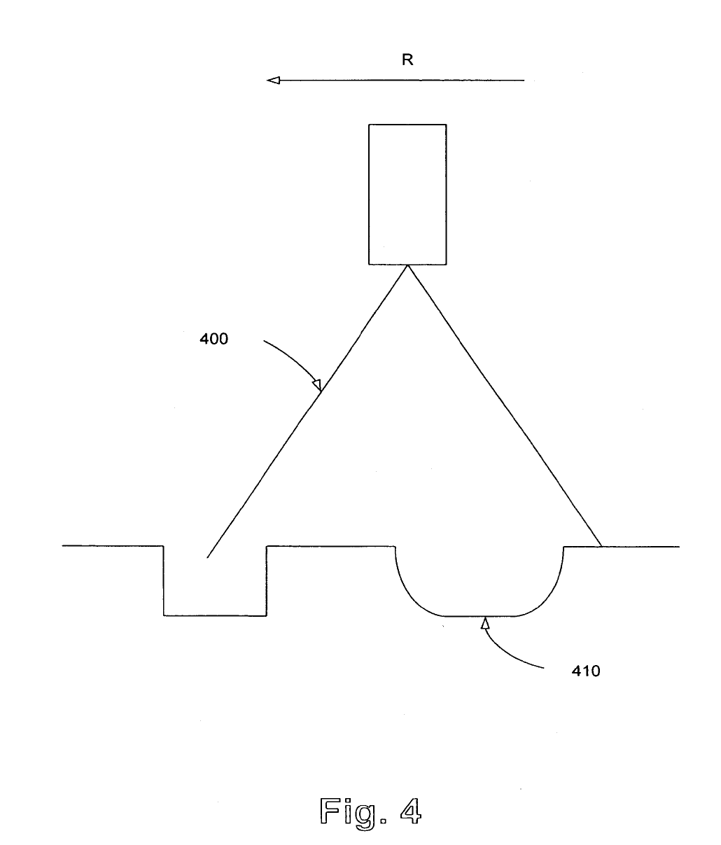

Additionally, according to one exemplary embodiment illustrated in FIG. 1, the inclusion of the air induction ports (160) on the outer surface (110) of the present exemplary cleaning apparatus (100) adjacent to the fan blades or impellers (150) allows for a modified orientation of the water jets (140), according to one exemplary embodiment. Specifically, as mentioned previously, traditional spinning surface cleaners orient the relative angle of the water jets at an extreme angle to provide a rotational force for the spinning of the apparatus. However, due to the placement of the air induction ports (160) on the outer surface (110) of the present exemplary cleaning apparatus (100) relative to the fan blades or impellers (150), the required driving force from the jets (140) is significantly reduced and/or eliminated. Consequently, the water jets (140) of the present exemplary cleaning apparatus (100) can be oriented to not only provide slight propulsion to spin the rotating coupler (130), but also to provide enhanced agitation for cleaning. Specifically, the water jets (140) of the present exemplary cleaning apparatus may be oriented, according to one exemplary embodiment, at between approximately 80 and 90 degrees relative to the plane defined by the bottom of the outer housing (115). According to one exemplary embodiment, the angle of orientation by the water jets (140) actually causes the leading edge (400; FIG. 4) of the spray to be pointed at a negative angle against the direction of rotation (R; FIG. 4), as shown in FIG. 4. Further details of the operation of the present exemplary cleaning apparatus (100) will now be provided below with reference to FIGS. 2 through 4.

### Exemplary Operation

Exemplary FIG. 2 illustrates an exemplary operation of the present exemplary cleaning apparatus (100), according to one exemplary embodiment. As illustrated in FIG. 2, once the tool (100) comes in contact with a surface being cleaned, vacuum is applied by the vacuum source (125) and a cleaning or rinsing solution is applied through the water jets (140) by any number of methods including, but in no way limited to, a machine for powering such tools such as a truck mounted or portable cleaning machine (not shown).

As the vacuum is introduced by the vacuum source (125), air is introduced to the housing (110) through the open air induction ports (160) above the impeller (150). Specifically, the vacuum created by the vacuum source (125) pulls air through the open air induction ports (160) and into the vacuum source, as indicated by the dashed arrows in FIG. 2. As illustrated, this air flow from the air induction ports (160) passes through the impeller (150) and out of the cleaning tool (100) to the vacuum producing source (125). As the air flow passes the impeller (150), a force is imparted on the surface of the blades of the impeller (150) causing the impeller to spin. As the impeller (150) begins to rotate, the high speed rotating coupler (130) also begins to spin. Rotation of the high speed rotating coupler (130) also rotates the water jets (140), causing the cleaning agent emitted from the water jets to be forced under pressure onto the surface being cleaned.

Specifically, according to one exemplary embodiment, the present exemplary system and method uses the introduction of air to drive the rotation of the jets (140) rather than solely using the water from the jets (140). According to the present exemplary embodiment, the use of a secondary propulsion input allows for the modified angle of the water jets (140) to be slightly less than a 90° angle. This extreme angle allows for the use of lower cleaning and rinsing solution pressures, thereby reducing the risk of damaging the surface being cleaned.

Further, as illustrated in FIG. 4, turning the jet angle (140) of spray more towards the direction of rotation allows for more intricate detailed cleaning of cracks or grooves (410) in the surface being cleaned. Particularly, the leading edge (400) of the spray may be pointed at a negative angle against the direction of rotation (R), allowing for more complete coverage of the surfaces of the cracks or grooves (410).

Moreover, the introduction of air via the inlet ports (160) provides positive air induction to the surface being cleaned. Consequently, the present exemplary system also completes dryer times more quickly and efficiently and eliminates the need for vacuum relief ports.

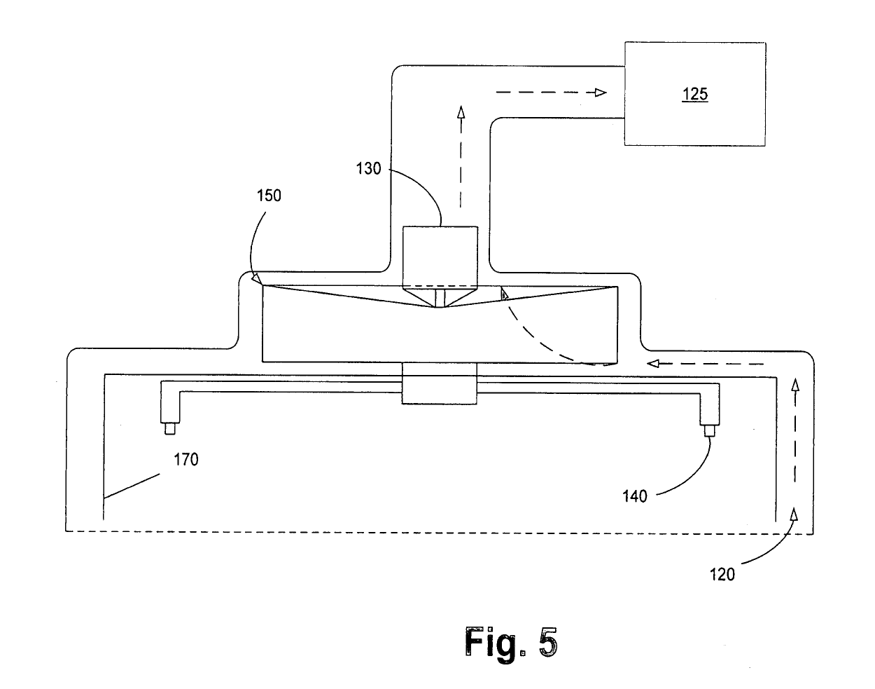

Referring now to FIG. 5, the driving of the impeller (150) may also be performed by a combination of air flow entering the apparatus (100) due to the existence of a vacuum and soiled water that has been used in the cleaning of a desired surface. As illustrated in FIG. 5, the air driven turbine (150) may be placed in the path between the vacuum port (120) and the vacuum hose leading to the vacuum source (125). Consequently, when the air and/or water that is present below the water jets is forced into the vacuum port(s) (120), the air and/or water may impart a force on the air driven impeller (150), imparting a rotational force thereon.

As shown in FIG. 5, the placement of the air driven impeller (150) in the path of the air and/or water that is passed to the vacuum source (125) efficiently utilizes the energy present in the system without necessitating extreme nozzle angles and other disadvantages of the prior art.

In conclusion, the present exemplary system and method use air and/or water to drive the rotation of a high speed rotating coupler assembly of a surface cleaning tool, thereby imparting a rotating force on the jet assembly. According to one exemplary embodiment, the present exemplary systems and methods allow for a more perpendicular spray jet angle and improved surface cleaning at lower speeds

The preceding description has been presented only to illustrate and describe exemplary embodiments of the present system and method. It is not intended to be exhaustive or to limit the system and method to any precise form disclosed. Many modifications and variations are possible in light of the above teaching. It is intended that the scope of the system and method be defined by the following claims.

What is claimed is:

1. An apparatus for cleaning solid surfaces comprising:
a housing configured to substantially encapsulate a surface being cleaned;
a vacuum port traversing said housing;
a high speed rotating coupler assembly rotatably coupled to said housing;
a plurality of impeller blades coupled to said high speed rotating coupler;
at least one fluid jet coupled to said impeller blades; and
at least one air pathway configured to pass input air past said impeller blades to rotatably drive said impeller blades.

2. The apparatus of claim 1, wherein said at least one air pathway comprises:
a plurality of air inlet ports formed in said housing adjacent to said plurality of impeller blades;
wherein said impeller blades are configured to rotate said high speed rotating coupler by air induced from said plurality of air inlet ports.

3. The apparatus of claim 1, wherein said fluid jet is configured to provide a leading edge of fluid at a negative angle against a direction of rotation of said fluid jet.

4. The apparatus of claim 1, wherein said least one air pathway comprises:
a channel defined between a vacuum port disposed in said housing and a vacuum source;
wherein said impeller blades are disposed in said channel.

5. The apparatus of claim 4, wherein said impeller blades are further configured to be driven by a combination of air and soiled water.

6. The apparatus of claim 5, further comprising an inner housing separating said impeller blades from said at least one fluid jet.

7. The apparatus of claim 1, wherein, said at least one fluid jet is oriented between 85 and 90 degrees relative to said solid surface.

8. An apparatus for cleaning solid surfaces comprising:
a housing configured to substantially encapsulate a surface being cleaned;
a high speed rotating coupler assembly rotatably coupled to said housing;
a plurality of impeller blades coupled to said high speed rotating coupler; and
at least one fluid jet coupled to said impeller blades;
wherein said impeller blades are configured to impart a rotational force on said at least one fluid jet.

9. The apparatus of claim 8, wherein said fluid jets are oriented between 85 and 90 degrees relative to said solid surfaces.

10. The apparatus of claim 8, further comprising a vacuum port traversing said housing.

11. The apparatus of claim 8, further comprising a plurality of air inlet ports formed in said housing adjacent to said plurality of impeller blades;
wherein said impeller blades are configured to rotate said high speed rotating coupler by air induced from said plurality of air inlet ports.

12. The apparatus of claim 8, wherein said fluid jet is configured to provide a leading edge of fluid at a negative angle against a direction of rotation of said fluid jet.

13. The apparatus of claim 10, wherein said vacuum port comprises:
a channel defined between a vacuum port inlet disposed in said housing and a vacuum source;
wherein said impeller blades are disposed in said channel.

14. The apparatus of claim 13, wherein said impeller blades are further configured to be driven by a combination of air and soiled water.

15. The apparatus of claim 14, further comprising an inner housing separating said impeller blades from said at least one fluid jet.

16. An apparatus for cleaning solid surfaces comprising:
a housing configured to substantially encapsulate a surface being cleaned;
a vacuum port traversing said housing;
a vacuum channel fluidly coupling said vacuum port to a vacuum hose;
a high speed rotating coupler assembly rotatably coupled to said housing;
a plurality of impeller blades coupled to said high speed rotating coupler; and
at least one fluid jet coupled to said impeller blades;
wherein said impeller blades are disposed in said vacuum channel.

17. The apparatus of claim 16, wherein said impeller blades are configured to rotate said high speed rotating coupler by air induced through said vacuum channel.

18. The apparatus of claim 17, wherein said impeller blades are configured to rotate said high speed rotating coupler by water induced through said vacuum channel.
